(19) United States
(12) Patent Application Publication
(10) Pub. No.: US 2018/0330335 A1
(43) Pub. Date: Nov. 15, 2018

(54) METHOD AND APPARATUS FOR ENABLING SCHEDULING OF A MEETING ACTIVITY BETWEEN A SERVICE PROFESSIONAL AND A CUSTOMER OF A SERVICE

(71) Applicant: THUMBTACK, INC., San Francisco, CA (US)

(72) Inventors: Xiaoyu S. Fei, Redwood City, CA (US); Garima Sinha, San Francisco, CA (US); Allison Shaw, San Francisco, CA (US); Timothy Carter, San Francisco, CA (US)

(21) Appl. No.: 15/594,513

(22) Filed: May 12, 2017

(51) Int. Cl. G06Q 10/10

(52) U.S. Cl. CPC G06Q 10/1095

(57) ABSTRACT

Exemplary methods for enabling the scheduling of a meeting activity between a service professional and a customer are described. A service professional is prompted to select a type of meeting activity from multiple meeting activities. The service professional is further prompted to enter structured information related to the meeting activity. The quotes including the meeting activity information are received from each service professional and transmitted to the potential customer. The customer is then enabled to accept the meeting activity, and provide additional information for the meeting activity. The potential customer is further enabled to modify one or more details of the meeting activity and transmit a response to the service professional. When the service professional and the potential customer agree on the meeting activity information, a notification message is transmitted to each one of the service professional and the potential customer including all details of the meeting activity.

### FIELD

Embodiments of the invention relate to the field of online marketplaces; and more specifically for enabling scheduling of a meeting activity between a service professional and a customer.

### BACKGROUND

Online marketplaces commonly exist for selling goods. For example, auction websites provide a portal for customers and service professionals to meet to buy and sell goods. An attraction of these websites is the ability for service professionals (either individuals or businesses) to sell their goods across the country.

Consumers currently have few options for transacting for services online. Certain websites exist that serve as a repository for reviews of business and/or services. These websites do not facilitate the booking and transaction of services. Also, attempts have been made to build out this functionality from a social network, which has the negative effect of pooling results based on social ties as opposed to geographic proximity Furthermore, few websites have focused on catering to both provider and consumer, choosing instead to tailor their websites to one side of the transaction.

In existing solutions, when a service professional and a customer attempt to schedule an activity related to a service to be offered, they need to exchange several messages (e.g., via emails or text messages) in order to obtain necessary information about the activity (e.g., date, time, phone number, location of meeting, etc.). This results in each one of them obtaining an unstructured set of information. However, this mechanism provide several disadvantages. For example, service professionals and customers receive unstructured formation in spread across several messages, which will cause them to go over a history of the exchanged messages in order to obtain or view all the information. Further they may need to exchange personal and sensitive information (e.g., name, email address, phone number) prior to obtaining a confirmation of the activity.

### BRIEF DESCRIPTION OF THE DRAWINGS

The invention may best be understood by referring to the following description and accompanying drawings that are used to illustrate embodiments of the invention. In the drawings:

FIG. 1A illustrates a graphical interface of web page of a request for service received by a service professional in accordance with some embodiments.

FIG. 1B illustrates a graphical interface of web page of an exemplary quote to be transmitted by the service professional in accordance with some embodiments.

FIG. 2A illustrates a graphical interface of a web page for scheduling a meeting activity in accordance with some embodiments.

FIG. 2B illustrates a graphical interface of a web page for scheduling a meeting activity, when the service professional selects not to recommend a meeting activity to the potential customer, in accordance with some embodiments.

FIG. 2C illustrates an exemplary graphical interface of a web page of a request inbox of a service professional, in accordance with some embodiments.

FIG. 3A illustrates an exemplary graphical interface of a web page for entering structured data related to the meeting activity in accordance with some embodiments.

FIG. 3B illustrates an exemplary graphical interface of a web page for entering structured data related to the meeting activity in accordance with some embodiments.

FIG. 3C illustrates an exemplary graphical interface of a web page for entering structured data related to the meeting activity in accordance with some embodiments.

FIG. 3D illustrates an exemplary graphical interface of a web page displayed to a service professional following the transmission of a quote in accordance with some embodiments.

FIG. 3E illustrates an exemplary graphical interface of a web page including a summary message of suggested meeting activity in accordance with some embodiments.

FIG. 4A illustrates an exemplary notification message received by a potential customer in response to a request for service in accordance with some embodiments.

FIG. 4B illustrates an exemplary graphical interface of a web page for a customer's quote inbox in accordance with some embodiments.

FIG. 5 illustrates an exemplary graphical interface of a web page of a first type of quotes received by the potential customer in accordance with some embodiments.

FIG. 6A illustrates an exemplary graphical interface of a web page of a second type of quotes received by the potential customer in accordance with some embodiments.

FIG. 6B illustrates an exemplary graphical interface of a web page of a second type of quotes received by the potential customer in accordance with some embodiments.

FIG. 6C illustrates an exemplary graphical interface of a web page of a second type of quotes received by the potential customer in accordance with some embodiments.

FIG. 6D illustrates an exemplary graphical interface of a web page of a second type of quotes received by the potential customer in accordance with some embodiments.

FIG. 6E illustrates an exemplary graphical interface of a web page of a second type of quotes received by the potential customer in accordance with some embodiments.

FIG. 7A illustrates an exemplary graphical interface of a web page of a third type of quotes received by the potential customer in accordance with some embodiments.

FIG. 7B illustrates an exemplary graphical interface of a web page of a third type of quotes received by the potential customer in accordance with some embodiments.

FIG. 7C illustrates an exemplary graphical interface of a web page of a third type of quotes received by the potential customer in accordance with some embodiments.

FIG. 7D illustrates an exemplary graphical interface of a web page of a third type of quotes received by the potential customer in accordance with some embodiments.

FIG. 8A illustrates an exemplary graphical interface of a web page of professional quote inbox in accordance with some embodiments.

FIG. 8B illustrates an exemplary graphical interface of web page of a summary message of a professional including all information needed for the agreed upon meeting in accordance with some embodiments.

FIG. 9A illustrates a graphical interface of a web page of a customer's quote list for a given request of service in accordance with some embodiments.

FIG. 9B illustrates an exemplary graphical interface of a web page of a summary message of a customer including all information needed for the agreed upon meeting in accordance with some embodiments.

FIG. 9C illustrates an exemplary graphical interface of a web page of a summary message of a customer including all information needed for the agreed upon meeting in accordance with some embodiments.

FIG. 10A illustrates an exemplary graphical interface of a web page of a list of quotes for enabling a professional to initiate the scheduling of a meeting activity with a customer of a marketplace of peer-to-peer services, in accordance with some embodiments.

FIG. 10B illustrates an exemplary graphical interface of a web page of a messenger of a professional account for enabling the professional to initiate the scheduling of a meeting activity with a customer of a marketplace of peer-to-peer services, in accordance with some embodiments.

FIG. 10C illustrates an exemplary graphical interface of a web page of a messenger of a customer account for enabling the customer to initiate the scheduling of a meeting activity with a professional offering services through a marketplace of peer-to-peer services, in accordance with some embodiments.

FIG. 11A illustrates a flow diagram of exemplary operations for enabling scheduling of a meeting activity between a service professional and a customer in accordance with some embodiments.

FIG. 11B illustrates a flow diagram of exemplary operations for enabling scheduling of a meeting activity between a service professional and a customer in accordance with some embodiments.

FIG. 12 is a block diagram illustrating an exemplary data processing system that may be used in some embodiments.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

A method and system for enabling scheduling of a meeting activity between a service professional and a customer of the service are described. A request for service from a potential customer is received. The request for service includes a set of parameters. The request for service is parsed to identify the set of parameters, which include at least a category of service wanted. A subset of service professionals from a set of potential service professionals is selected. The request for the service is transmitted to the selected subset of service professionals. Each service professional is enabled to prepare a quote for the service to be offered.

In some embodiments, during a quotation process, a graphical user interface is presented to a service professional and/or a customer to enable scheduling of a meeting activity related to the service to be offered. When the service professional prepares the quote for the service, they are enabled to enter a meeting activity to be transmitted with the quote. In some embodiments, the service professional is prompted to select a type of meeting activity from multiple meeting activities. The service professional is further prompted to enter structured information related to the meeting activity. For example, the service professional is prompted to enter at least one date and time for the meeting activity. The quotes may be received from each service professional from the subset of service professionals. The quotes including the meeting activity information are transmitted to the potential customer. In some embodiments, only a subset of the quotes received from the service professionals are transmitted to the potential customer. The customer is then enabled to accept the meeting activity, and provide additional information for the meeting activity. In some embodiments, the potential customer is further enabled to modify one or more details of the meeting activity and transmit a response to the service professional. When the service professional and the potential customer agree on the meeting activity information, a notification message is transmitted to each one of the service professional and the potential customer including all details of the meeting activity.

The embodiments of the present invention enable an efficient and streamlined process for both the service professional and the potential customer for setting a meeting activity. The system enables the service professional and the potential customer to obtain and store structured information (e.g., date, time, type of activity, location, contact information, etc.) related to the meeting activity without the need for exchanging several messages.

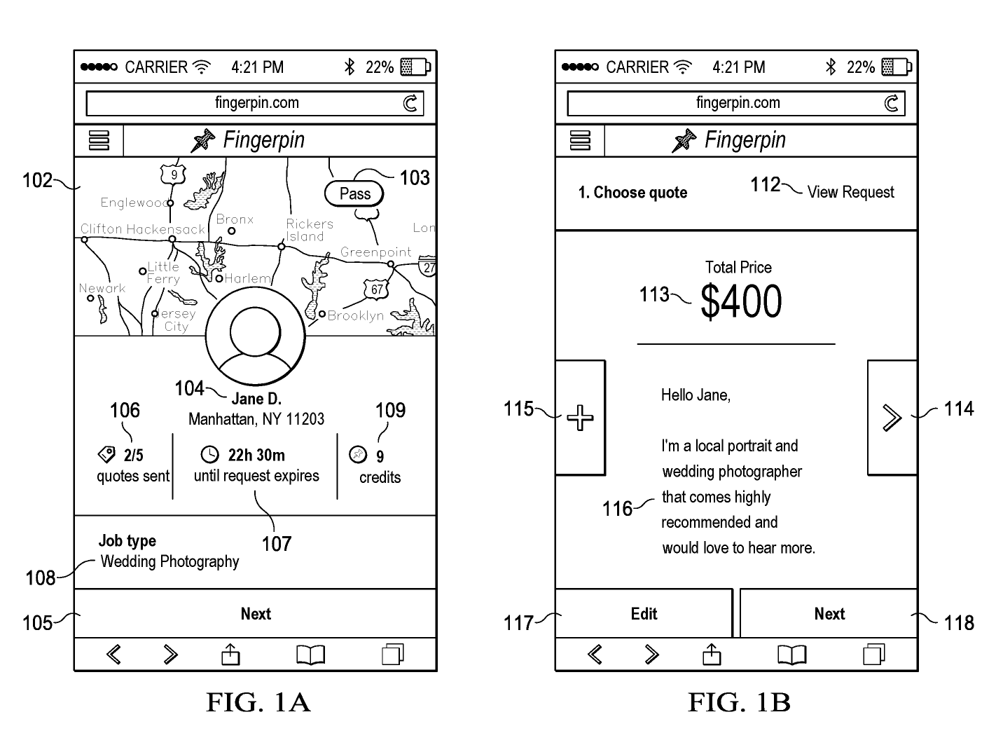

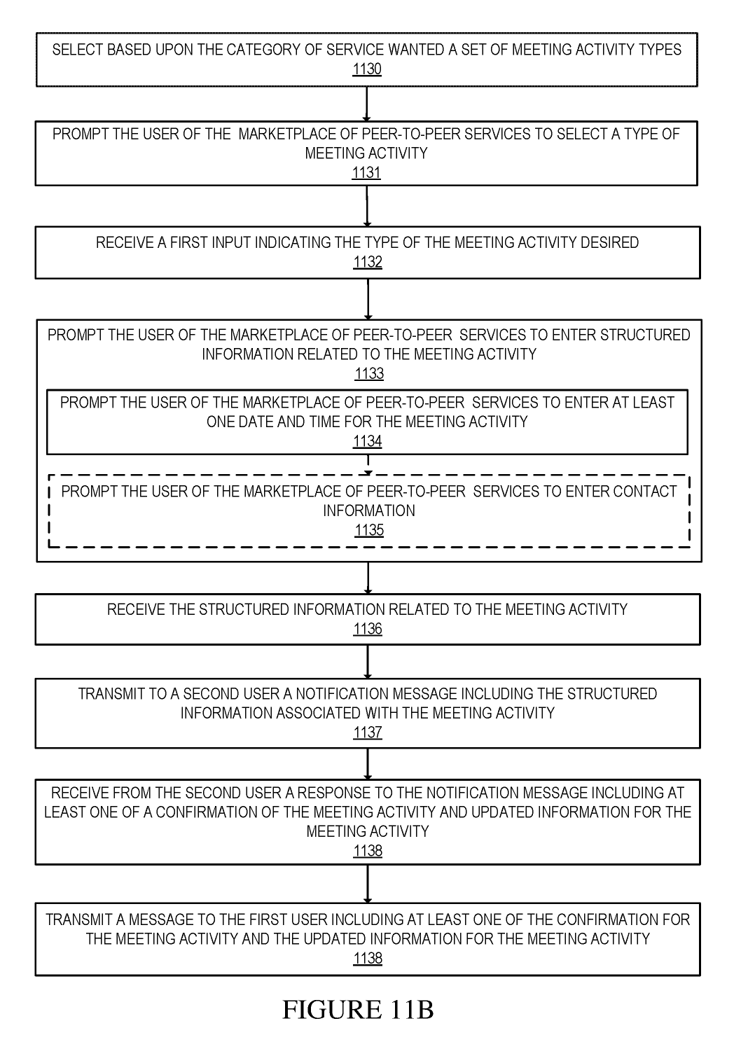

A method and apparatus for a marketplace for peer-to-peer services is described. FIGS. 1A-10C illustrate exemplary graphical user interface for enabling scheduling of a meeting activity according to some embodiments of the invention. According to some embodiments of the invention, FIGS. 1A-10C are web pages of a marketplace for peer-to-peer services. FIGS. 1A-10C will be described with reference to the operations of FIGS. 11A-B. However, it should be understood that the operations of FIGS. 11A-11B can be performed by embodiments of the invention other than those discussed with reference to FIGS. 1A-10C, and the embodiments of the invention discussed with reference to FIGS. 1A-10C can be performed by operations different than those discussed with reference to FIGS. 11A-B.

FIG. 1A illustrates one example of a graphical user interface for a service professional to prepare a quote for a service following a receipt of a request for the quote, in accordance with some embodiments. A service professional (sometimes referred to as a professional) is typically an individual or a company that offers services to potential customers at a given location. A potential customer (which may be referred to as “customer”) is typically an individual or company that wants a service performed at a given location and possibly purchases one or more of those services.

FIG. 11A illustrates a flow diagram of exemplary operations for processing a request for service performed through a peer-to-peer services marketplace according to one embodiment of the invention. A request for service is received, at operation 1105, from a potential customer. The request for service includes a plurality of parameters. The request for service is parsed, operation 1110, to identify the plurality of parameters. The plurality of parameters includes at least a category of service wanted and may also include the location where the service is desired, among other parameters. A matching operation is performed to determine a subset of service professionals from a plurality of service professionals that is best suited to do the job, at operation 1115. The request for service is transmitted, at operation 1120, to the selected subset of service professionals. Each service professional is enabled, at operation 1125, to prepare a response for the service to be offered, which is referred herein as a quote. Alternatively, instead of sending the request to the selected subset of service professionals, a quote is automatically generated on behalf of each of the selected subset of service professionals and sent to the requesting customer. In such an embodiment, the professional provides configuration information such as what customers they are willing to respond to and the types of jobs that they are willing to accept. The professional may provide information regarding the number of jobs they can take in a given period of time. As will be discussed in further details below, during the quote preparation process, a service professional and a customer are enabled to schedule a meeting activity by exchanging a structured set of information related to the meeting activity.

FIG. 1A illustrates a graphical interface of a web page of a request for service received by a service professional in accordance with some embodiments. In the non-limiting example of FIG. 1A, the web page is displayed on a web browser of a mobile electronic device (e.g., web browser of a smart phone). However one of ordinary skill in the art will understand that the embodiments are not so limited and the graphical interface can be presented on other types of electronic devices. For example, the graphical interface can be displayed on a web browser of a desktop electronic device. In another example, the graphical interface can be a standalone application (also referred to as “app”) running on the mobile electronic device. Other examples can be contemplated without departing from the scope of the present invention.

The graphical interface includes elements 102-109 illustrated in FIG. 1A. Element 102 illustrates a map that shows a location where the service is queried. Typically, the location indicates where the potential customer is located and/or how far the potential customer is willing to travel to purchase services. The location is entered by the customer when preparing the request for the service. The location may be entered as a city, a street within a city, a zip code, etc. In one embodiment of the invention, when a potential customer is logged in, the location of the potential customer is automatically populated with the address used during registration (which the potential customer may change). The graphical interface includes a button 103 “Pass.” The button 130 enables the service professional to not submit a quote for the service queried and causes the service professional to skip the following steps of the quotation process. Graphical element 104 includes a user name of the customer requesting the service. For example, the user name is a name created by the user for an account when registering for the peer-to-peer marketplace service. Typically the username of the customer does not include the complete or real name of the customer enabling the customer to not share their identity at the time of submission of the request. Graphical element 106 indicates a number of quotes already sent for the queried service. As illustrated in FIG. 1A, in some embodiments, the element 106 indicates a number of quotes sent (here 2 quotes) vs. a maximum number of quotes allowed for the queried service. In other embodiments, this graphical element is optional and not displayed on the graphical interface. The graphical interface further includes graphical element 107, which indicates a time limit after which the request expires. When the requests expires, the service professional is no longer able to submit a quote in response to this request. Graphical element 109 indicates an amount of credit will cost the professional for sending the quote. When the professional transmits the quote to the customer, the number indicated by graphical element 109 is subtracted from the professionals bank of credits. In some embodiments, the service professional has enrolled in the peer-to-peer marketplace service and has purchased a predetermined number of credits allowing them to submit quotes to service requests received In some embodiments, the service professional may only submits quotes when there is a sufficient amount of credit associated with their account.

The graphical interface includes a graphical element 108 indicating the category of service received in the request (here “Wedding Photography”). The “Next” button 105, when selected by the service professional, directs the service professional to a quote preparation page which will be described in greater detail with reference to FIG. 1B. Of course, it should be understood that other graphical interfaces can be presented to the service professional for receiving a request for service. For example, some of the fields and buttons may not be present (e.g., fields 106, 107, and 109). It should be understood that the number and type of fields illustrated in FIG. 1A is exemplary and alternative embodiments may have more fields, less fields, fields that have combined functionality, etc. In addition, it should also be understood that although FIG. 1A illustrates the fields and buttons located at given locations within a web page, this is intended to be exemplary only and other alternative locations can be contemplated without departing from the scope of the present invention.

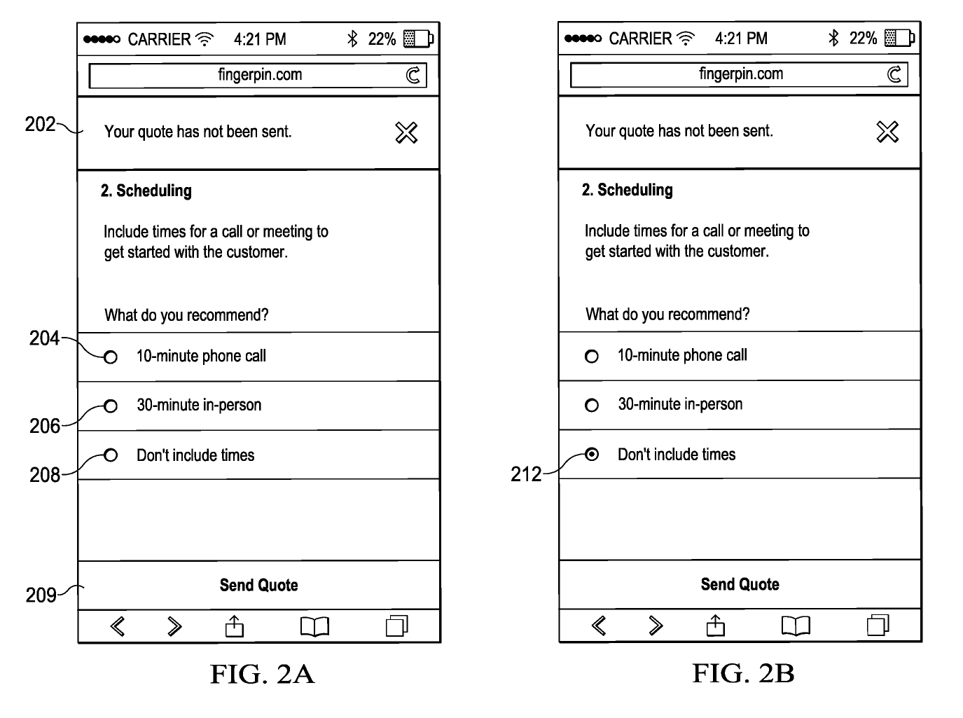

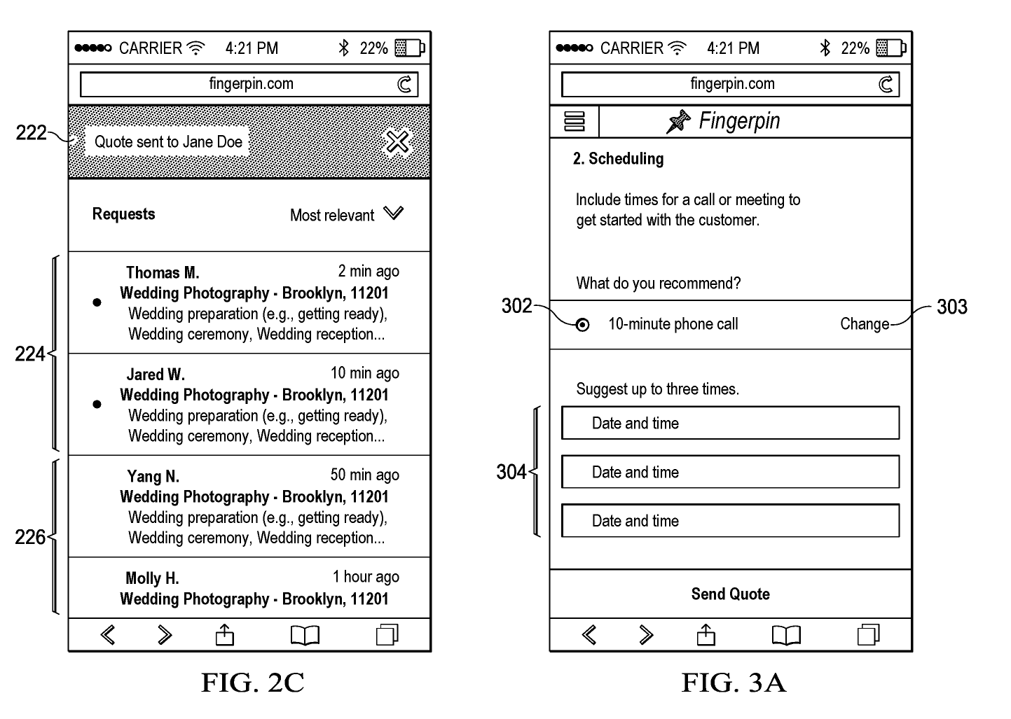

FIG. 1B illustrates a graphical interface of a web page of an exemplary quote to be transmitted by the service professional in accordance with some embodiments. The page of FIG. 1B includes a quote to be selected in response to the request for service. The quote includes a graphical element 113 indicating a price for the service offered by the service professional, and a graphical element 116 including a message to be transmitted to the potential customer with additional details about the service to be performed by the service professional for the indicated price. The page further includes a button 112 “view request” that enables the service professional to return to the page including the request for service (i.e., return to page of FIG. 1A). FIG. 1B further includes button 114 that enables the service professional to view multiple pre-stored quotes and select one of the pre-stored quotes. In some embodiments, the service professional has already defined, at a previous time, a set of quotes that include a predetermined price and message associated with it. At the time of preparation of a quote in response to the current request for service, one of the orders is automatically adapted for the current service request. For example, the quote is automatically adapted to address the message to the customer sending the request. The page further includes a button 115 that enables the service professional to add a new quote for the requested service. When selected, button 117 enables the service professional to edit the quote displayed. Editing the quote includes changing the quoted price for the service 113 and/or modifying the message 114 that describes the service to be performed. The button 118, when selected, enables the service professional to select the displayed quote and directs the service professional to a scheduling page which will be described in greater detail with reference to FIG. 2A.

FIG. 2A illustrates a graphical interface of a web page for scheduling a meeting activity in accordance with some embodiments. The page of FIG. 2A includes a notification message 202 that indicates to the service professional that the selected quote has not yet been transmitted. Through the page of FIG. 2A, the service professional is prompted (operation 1040) to select a type of meeting activity to suggest to a potential customer. In some embodiments, the meeting activity can be any type of activity to be performed by the service professional and the potential customer prior to the customer hiring the service professional to perform the service. In other embodiments, the meeting activity can be a first step in the service performed after the potential customer has hired the service professional. In the illustrated example, the service professional is provided with three options: recommending to the potential customer, by selecting button 204, a 10 minute phone call; recommending to the potential customer, by selecting button 206, a 30-minute in-person meeting; not recommending any meeting activity by selecting button 208. The page of FIG. 2A further includes a button 209, which when selected enables the service professional to immediately send the quote to the potential customer by skipping, at any time, any further steps of the quotation process. For example, if button 209 is selected, the service professional is directed to the page of FIG. 2C.

While FIG. 2A illustrates two options from which the service professional is to choose a meeting activity (i.e., a 10 minute phone call or a 30 minutes in person meetings) in other embodiments, the list of meeting activities can include additional or fewer options. In some embodiments, the list of meeting activities may include several options for each type of meeting activity (e.g., the list may include a set of phone call options with varying lengths, or a set of in-person activities with varying lengths, etc.). In some embodiments, the list of meeting activities can be pre-configured by the service professional during a set up phase, such that for each quote a set of one or more meeting activities is associated. In other embodiments, the list of meeting activities is automatically determined by the marketplace and is adapted to the category of service offered. For example, it may be determined that some services offered may not need a phone call but instead an in person meeting would be more suitable or vice versa. In some embodiments, an analysis based on data collected from previous quotes including meeting activities can be used within a heuristics model to determine which meeting activity is to be recommended (and consequently displayed to a professional) for a given category of service. In some embodiments, the operations of selecting the type of meeting activity may be skipped when the system automatically determines which type of meeting activity is suitable for a given quote and/or service category. In these embodiments, the service professional is prompted to enter structured information related to the meeting activity (e.g., dates and times for the meeting activity) directly without having to select the type of meeting activity.

In some embodiments, when prompted to select a type of meeting activity, the service professional selects not to recommend a meeting activity by selecting button 208, as illustrated in FIG. 2B. FIG. 2B illustrates a graphical interface of a web page for scheduling a meeting activity when the service professional selects not to recommend a meeting activity to the potential customer, in accordance with some embodiments. The service professional further selects button 209, which when selected enables the service professional to immediately send the quote to the potential customer by skipping any further steps of the quotation process. For example, if button 209 is selected, the service professional is directed to the page of FIG. 2C.

FIG. 2C illustrates an exemplary graphical interface of a web page of a request inbox of a service professional, in accordance with some embodiments. This web page is displayed to the service professional when a quote has been sent to the potential customer. The page includes an indication (222) that the quote was sent to the customer. The page also includes a set of requests (224, 226). The set of requests may include a first subset of requests 226 that were previously viewed by the service professional. The set of requests may further include a second subset of requests 224 that were not yet viewed by the service professional.

In alternative embodiments, when prompted to select a type of meeting activity (referring back to FIG. 2A), the service professional may select one of 204 and 206 to identify a type of meeting activity to recommend to the potential customer as a next step to be taken by both the service professional and the potential customer. As described above, this next step can be part of the service offered (e.g., a first meeting or phone call to discuss in further details the service once the customer has hired the service professional). Alternatively, the meeting activity is to occur prior to the customer hiring the service professional and the occurrence of the actual service.

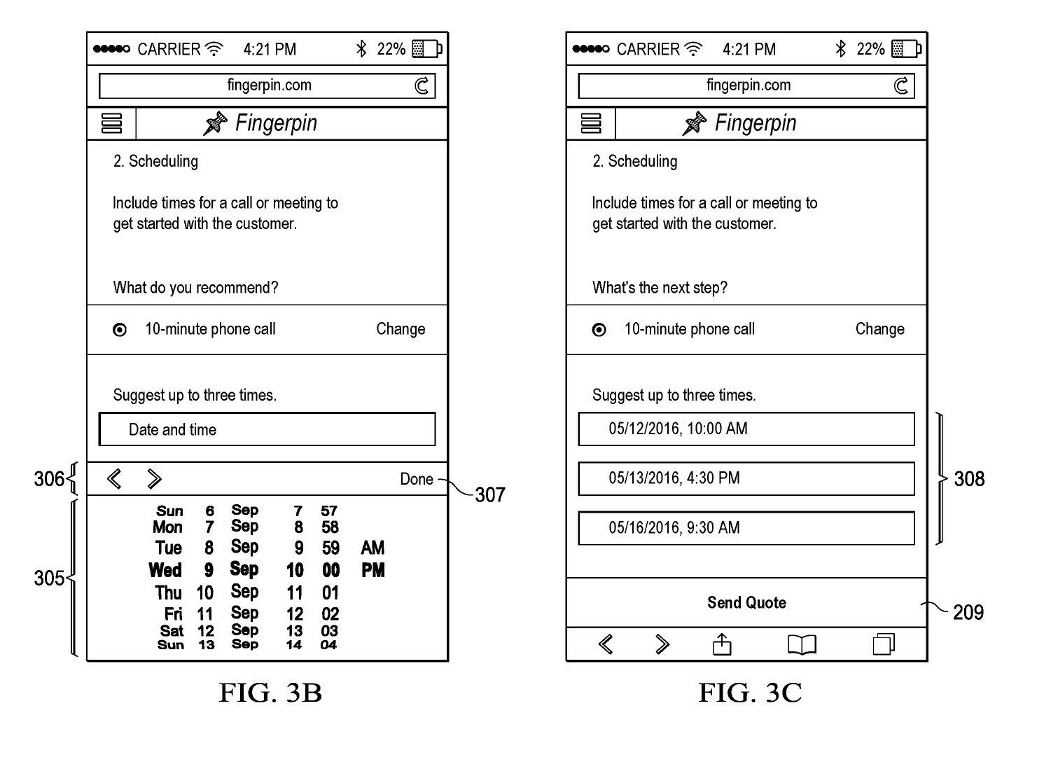

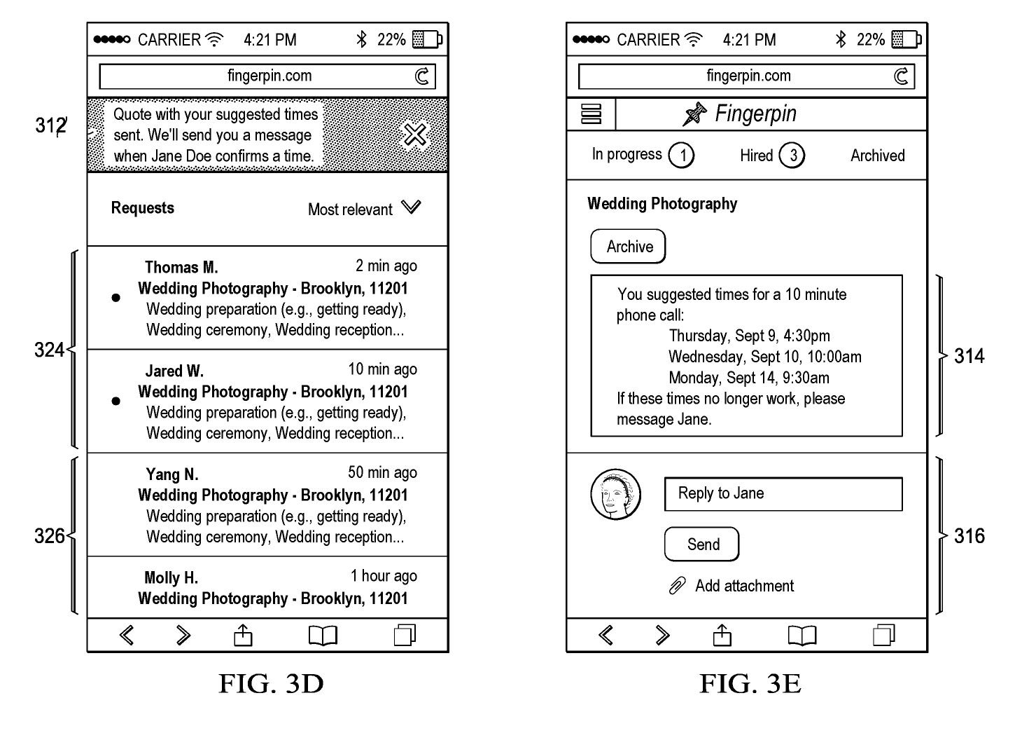

FIGS. 3A-E illustrate exemplary graphical interface of web pages for entering structured information (operation 1045) related to the meeting activity in accordance with some embodiments. In FIG. 3A, the service professional selects a phone call type of meeting activity by checking the button 204 (which is illustrated as the selected button 302 in FIG. 3A). Once the selection is made, the service professional is enabled to modify the selection by selecting the button “change” 303. When a type of meeting activity is selected, the service professional is prompted to enter structured information about the meeting. For example, the service professional is prompted to enter up to three choices for a meeting date and time, through the graphical elements 304.

The page of FIG. 3B illustrates an exemplary graphical interface provided to the service professional for selecting a date and time for a meeting activity. The service provider may scroll up or down the elements 305 to select a day of the week and time for the meeting. The arrows 306 may be used to scroll through months/years to select a given month or year for setting the meeting activity. In some embodiments, the account of the service professional may be synchronized with one or more calendars of the service professional. For example, the account of the service professional may be synched to a calendar of a third party application, consequently enabling the selection of the date and time to be performed based on availability of the service professional with respect to already scheduled activities stored in the third part calendar. For example, the system is operative to analyze the calendar of the third party application and present in the graphical interface only dates/times at which the service professional is known to be available.

When a date and time are selected, the service professional may confirm the selection by using the button 307 (“done”). The service professional may repeat this process for N meeting activity dates and times. While in the illustrated example, three potential meeting dates and times are shown, the service professional can be enabled to enter any desired number of meeting. FIG. 3C illustrates a page including three dates/times (308) entered by the service professional to be transmitted to the potential customer for the meeting activity. When all the meeting dates and times are entered the service professional may select to send the quote by using the button 209.

FIG. 3D illustrates an exemplary graphical interface of a web page displayed to a service professional following the transmission of a quote in accordance with some embodiments. When the service professional selects to send, to the potential customer, the quote with one or more dates and times for a meeting activity, the system receives the selected times and dates and displays a request inbox of the service professional. The page includes an indication (312) that the quote was sent to the customer with suggested dates and times for one or more activity meeting. As discussed above, the page also includes a set of requests (324, 326). The set of requests may include a first subset of requests 326 that were previously viewed by the service professional. The set of requests may further include a second subset of requests 324 that were not yet viewed by the service professional.

Following the receipt of the quote including one or more activity meetings selected by the service professional, the system sends the quote to the potential customer. In some embodiments, upon receipt of several quotes from different service professionals, the system may select a subset of these quotes to be transmitted to the potential customer. The system further transmits a confirmation notification message to the service professional indicating that the quote was transmitted with the recommended activity meetings. FIG. 3E illustrates an exemplary graphical interface of a web page including a summary message of suggested meeting activities. The summary message is displayed in response to the notification message received from the system. The notification message can be an email message, a text message, a voice message, etc. The message 314 includes a summary of the meeting activities suggested by the service professional. The service professional is further enabled through the graphical elements 316 to directly communicate with the potential customer (by transmitting a message to the potential customer or an attachment (e.g., a photograph, or another type of files)). The service professional may for example, communicate with the potential customer to suggest a change to the proposed times and dates of the meeting activity.

In the embodiments when the quote is automatically generated by the system on behalf of a service professional, the system may automatically generate a meeting activity and associated dates and times for the meeting activity to be transmitted with the quote to the potential customer. In some embodiments, the service professional may provide information regarding a type of meeting activity desired. In another embodiment, when the quote is automatically generated instead of generating a meeting activity, the system enables the customer upon receipt of the automatically generated quote to create the meeting activity and recommend one or more dates and times for the meeting activity.

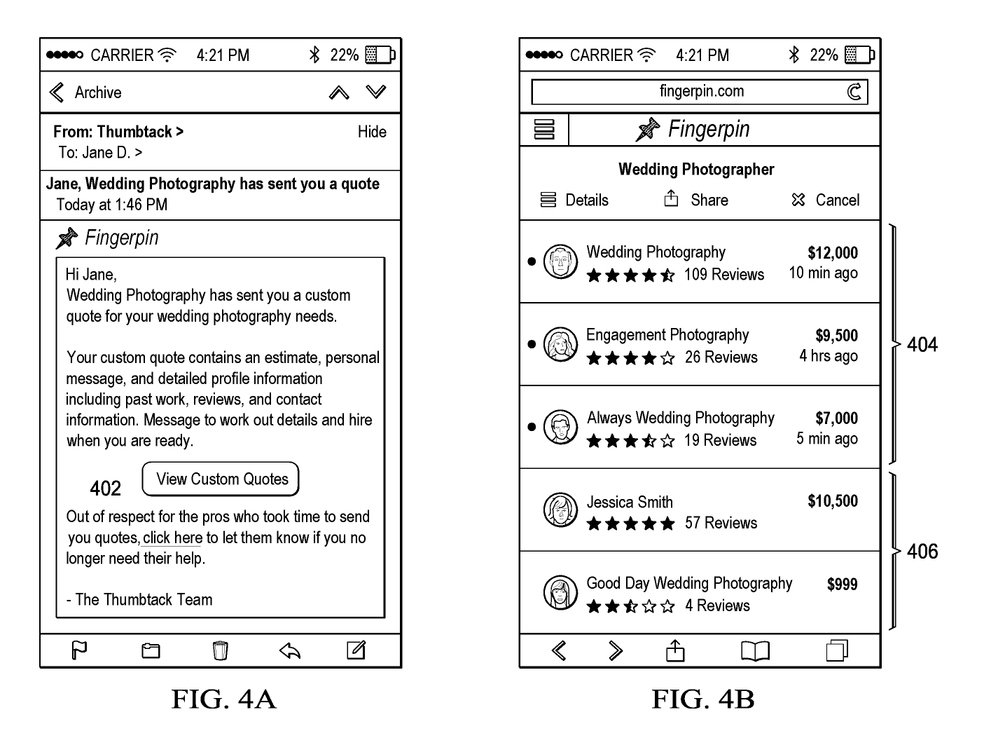

FIG. 4A illustrates an exemplary notification message received by a potential customer in response to a request for service in accordance with some embodiments. As discussed above, upon receipt of a quote from a service professional, the system determines whether to transmit the quote to the potential customer or not. In some embodiments, all quotes received from each one of the selected service professional is sent to the potential customer. In other embodiments, a subset of quotes is selected to be transmitted. The system transmits a notification message to the potential customer (e.g., the system may transmit an email (e.g., FIG. 4A) or a text message (not shown) as the notification message) indicating that a new quote has been received for the requested service. The potential customer is prompted to visit the hyperlink 402 to access an inbox of quotes.

FIG. 4B illustrates an exemplary graphical interface of a web page for a customer's quote inbox in accordance with some embodiments. The page includes a set of quotes (404, 406) received by the customer through the marketplace system. In some embodiments, the set of quotes received by the customer is a subset of all quotes submitted by various service professionals. The set of quotes may include a first subset of quotes 406 that were previously viewed by the customer. The set of requests may further include a second subset of requests 404 that were not yet viewed by the customer. Thus the customer is prompted to select one of the received quotes to view further details about the quote as will be described in further details below. Each quote may include several details about one or more meeting activities recommended by the service professional submitting the quote.

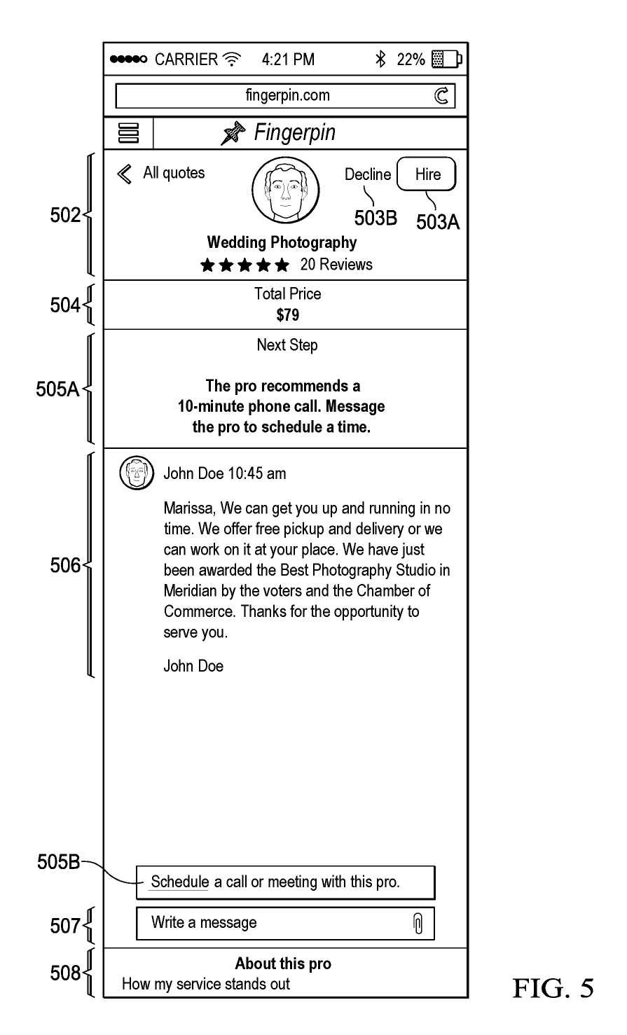

FIG. 5 illustrates an exemplary graphical interface of a web page of a quote received by the potential customer in accordance with some embodiments. The page of FIG. 5 includes an identification 502 of the service professional. The identification of the service professional may include a photograph, a name and a ranking of the service professional and one or more reviews. The page further includes a “hire” button 503A, which when selected enables the customer to hire the service professional for performing the requested service. The page further includes a “decline” button 503B, which when selected enables the customer to decline hiring (and discard the quote) the service professional for performing the requested service. The page further includes a price 504 quoted by the service professional for the service, and a “next step” 505A suggested by the service professional. In the illustrated example, while the service professional (here referred to as “pro” in FIG. 5) recommends a meeting activity (10-minute phone call), there is no proposed times and dates displayed for the meeting activity (next step) suggested by the professional.

In some embodiments, the illustrated graphical interface of FIG. 5 can be displayed to the customer when a pro has suggested one or more meeting times and these times have expired. For example, if a pro suggests a phone call on a given day (Tuesday) at a predetermined time (e.g., 10 AM), and the customer looks up the quote after that day or time has passed, the expired times are not displayed in the graphical interface of FIG. 5. This results in the quote being displayed as the exemplary web page of FIG. 5, where the next step section 505A does not include any dates and times suggested. In other embodiments, the illustrated graphical interface of FIG. 5 can be displayed to the customer when a pro had selected a type of next step activity (e.g., phone call, in-person meeting, video conference meeting, etc.), while not suggesting specific times and dates for the meeting.

In this exemplary embodiment, the graphical interface includes a button 505B “schedule” which when selected by the potential customer, enables the customer to enter structured information related to the meeting activity. The potential customer is prompted to select a type of activity (when a different activity from the one already proposed by the professional is chosen) and one or more dates and times for the activity. In a similar manner as the process described for the professional (FIGS. 3A-E, where the professional selects the meeting activity information), the system enables the customer to select suggested dates and times and transmits a notification to the professional indicating that a new message is received from the customer. The professional may then access their account and view the list of meeting activities suggested by the customer.

The page of FIG. 5 further includes a message 506, indicating further details about the quote, a text box 507 for writing messages to the professional, and a graphical element 508, “About the pro” that enables customer to view additional information related to the professional (not shown).

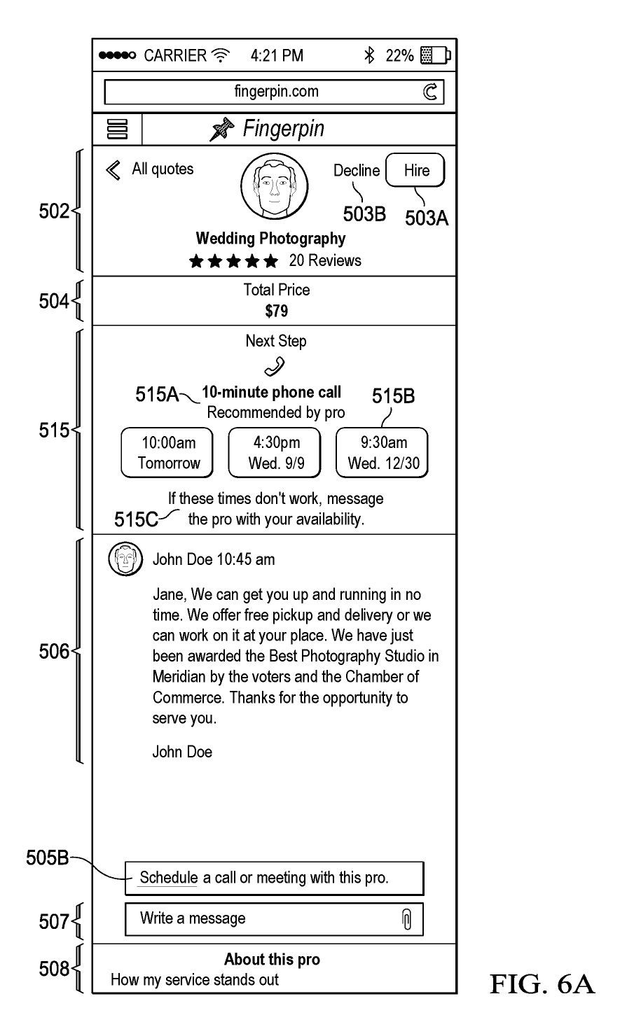

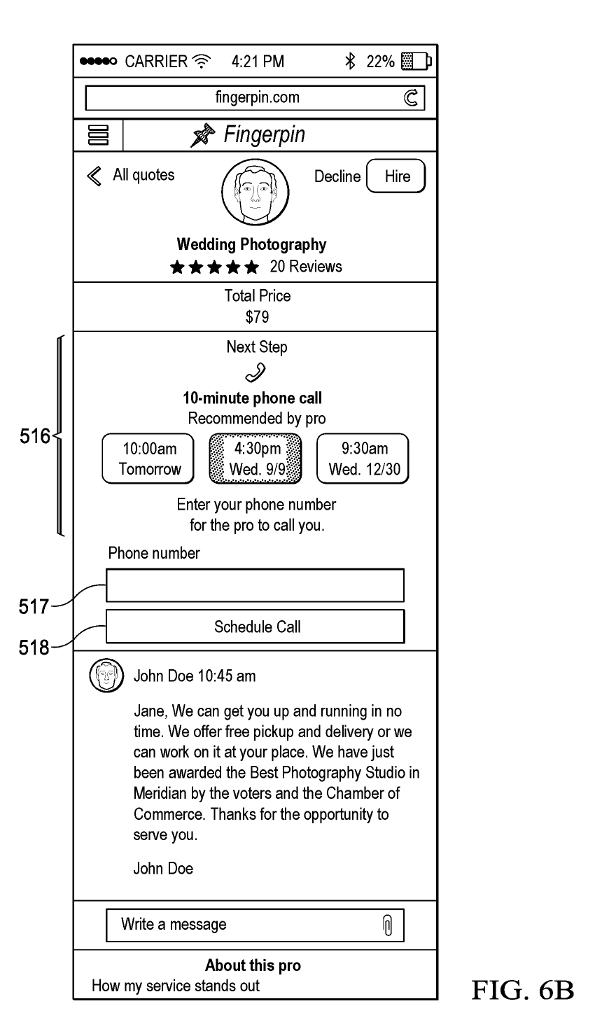

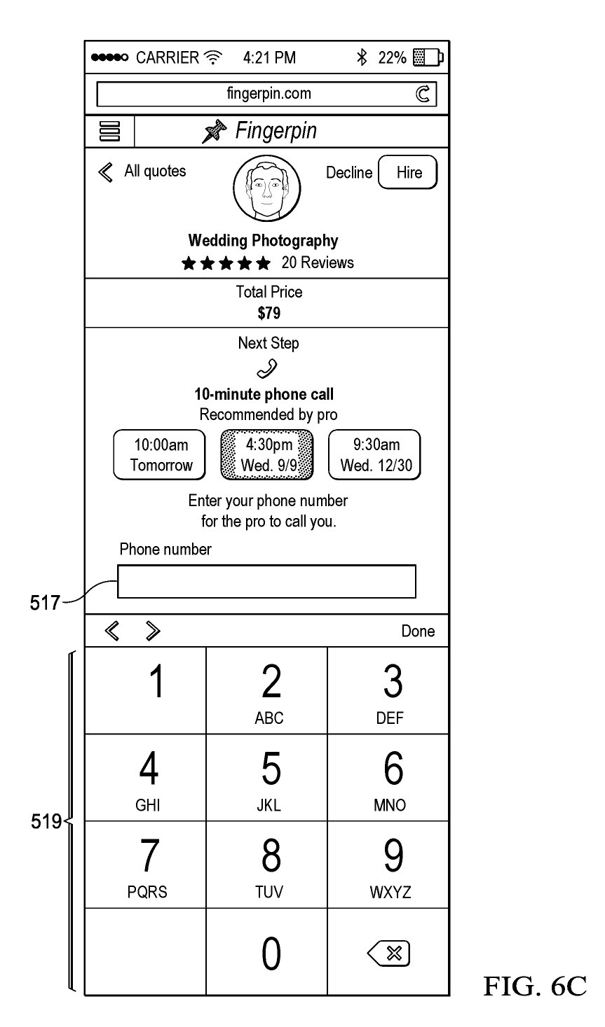

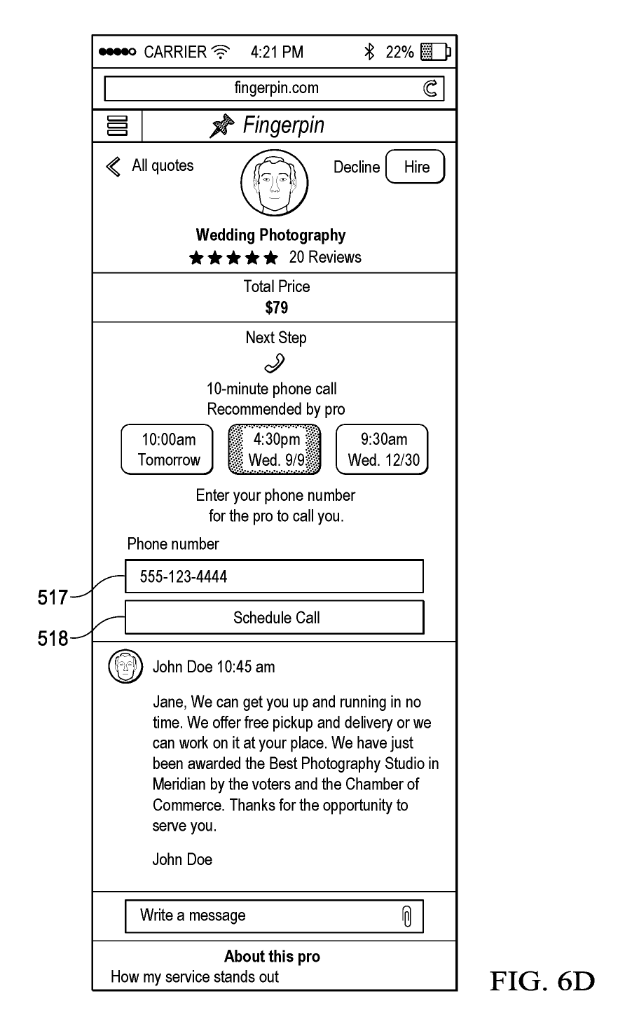

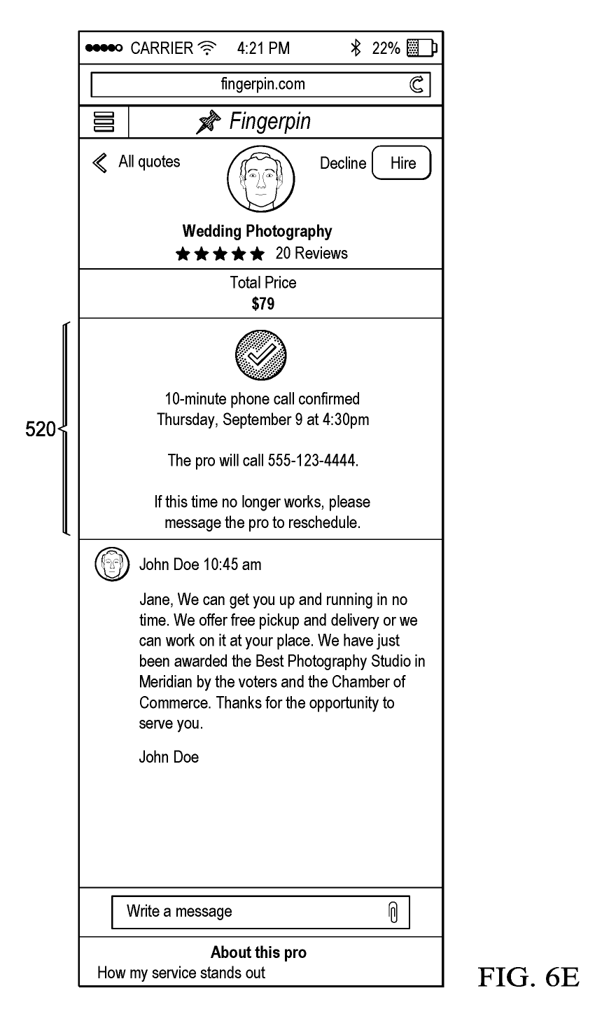

FIGS. 6A-E illustrate exemplary graphical interfaces of web pages of a quote received by the potential customer in accordance with some embodiments. The page of FIG. 6A includes similar parts and fields as the page of FIG. 5. For example, the page includes an identification 502 of the service professional. The identification of the service professional may include a photo, a name and a ranking of the service professional and one or more reviews. The page further includes a price 504 quoted by the service professional for the service. The page further includes a “hire” button 503A, which when selected enables the customer to hire the service professional for performing the requested service; and a “decline” button 503B, which when selected enables the customer to decline hiring (and discard the quote) the service professional for performing the requested service. The page includes a message 506, including a customized text with additional details about the quote and/or the service professional; a text box 507 for writing messages to the professional; and a graphical element (508) “About the pro” that that enables the customer to view additional information related to the professional (not shown).

The page also includes a “next step” 515 suggested by the service professional. In the illustrated example, the service professional (here referred to as “pro” in FIG. 6A) recommends a meeting activity 515A of type “10-minute phone call,” and suggests three different days/times 515B for the meeting activity. In some embodiments, when the system is aware of the location of the customer, prior to transmitting the quote to the customer, the system may account for varying time zones by automatically translating the time/date entered by the service professional into a date/time of the time zone of the customer. The next step section 515 further includes a message 515C indicating to the customer that the proposed dates and times can be modified by transmitting a message to the service professional. The customer is prompted to select one of the three suggested dates/times or to contact the professional for setting alternative times and dates for the meeting.

In the scenario, where the customer decides to decline the proposed times/dates, the customer is prompted to select a type of activity and one or more dates and times for the activity. In this exemplary embodiment, the graphical interface includes a button 505B “schedule” which when selected by the potential customer, enables the customer to enter structured information related to the meeting activity. The potential customer is prompted to select a type of activity (when a different activity from the one already proposed by the professional is chosen) and one or more dates and times for the activity. In a similar manner as the process described for the professional (FIGS. 3A-E, where the professional transmits the suggested meeting activity information), the system enables the customer to select alternative dates and times and transmit a notification to the professional indicating that a new message is received from the customer. The professional may then access their account and view the list of meeting activities suggested by the customer.

In the alternative scenario, where the customer selects one of the suggested times/dates 515B the page as illustrated in FIG. 6B is displayed. Section 516 of the web page of FIG. 6B highlights the selected time/date and the customer is prompted to enter a phone number in text box 517. When the customer selects text box 517, a set of numbers 519 is displayed (as illustrated in FIG. 6C) to enable the customer to enter the phone number at which the service professional is to call them at the time of the meeting. Once the customer enters the phone number in text box 517 (as illustrated in FIG. 6D), they may schedule the meeting activity by selecting the button 518. FIG. 6E illustrates an exemplary graphic interface of a web page of when the scheduling of the meeting activity is confirmed by the customer. When the customer has completed entering the requested information (e.g., date, time and phone number in this example) and confirmed the meeting activity by selecting the “scheduling call” button 518, a confirmation 520 is indicated to the customer including a summary of the agreed upon meeting activity with the associated meeting details (e.g., date, time, call information, etc.).

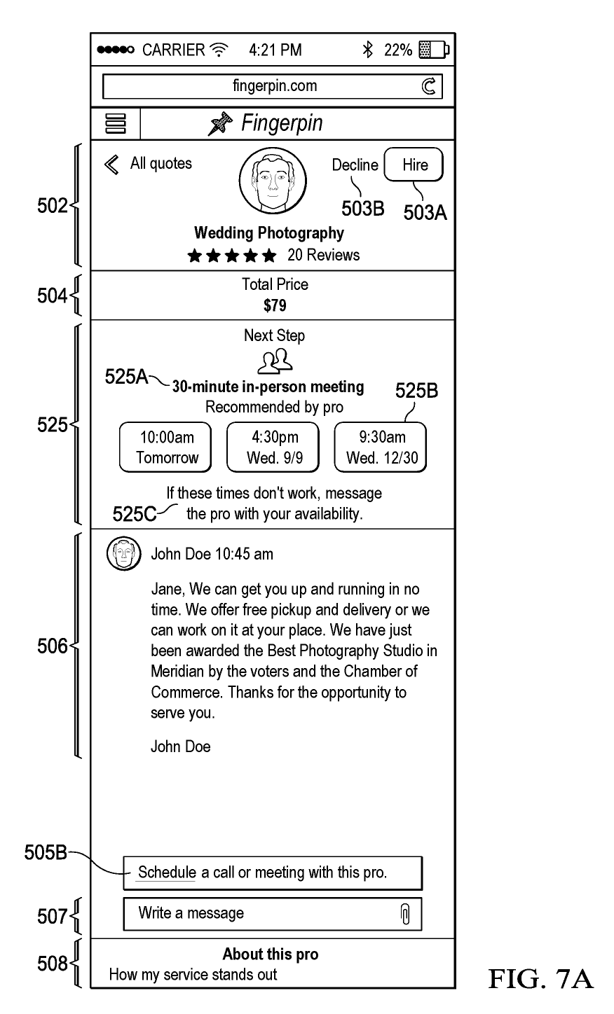

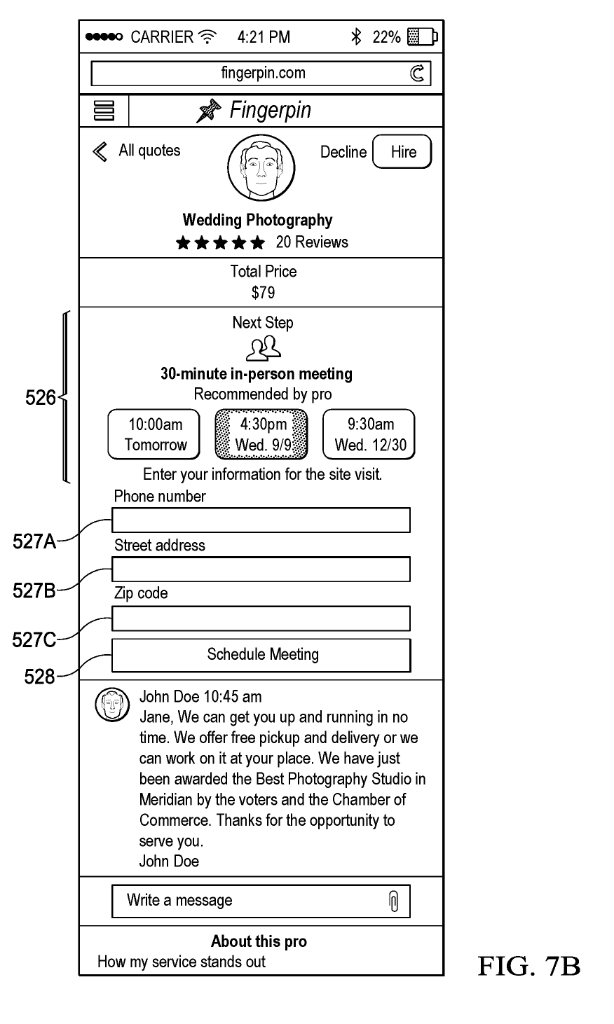

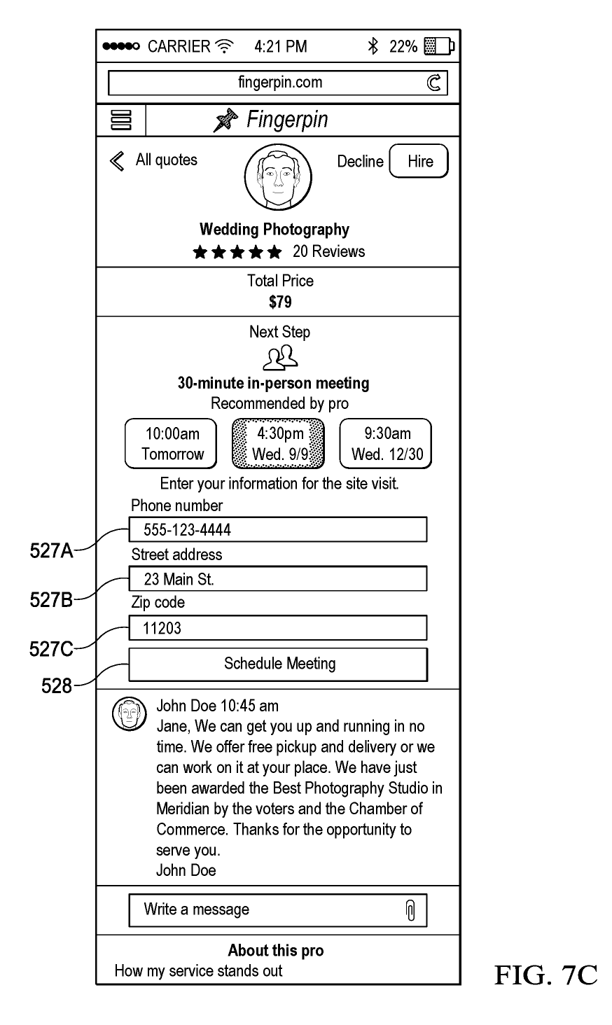

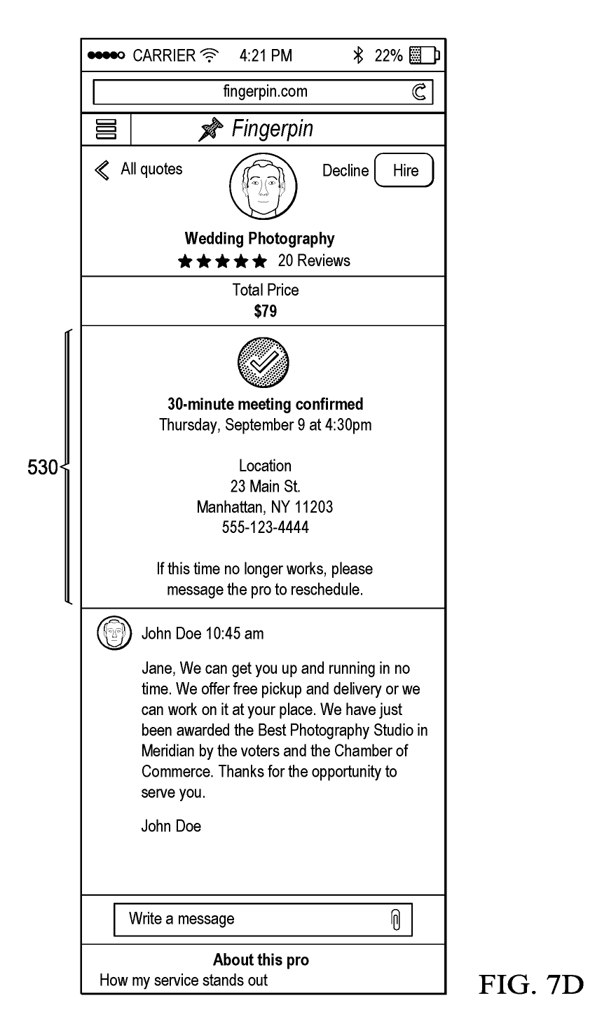

FIGS. 7A-D illustrate exemplary graphical interfaces of web pages of a quote received by the potential customer in accordance with some embodiments. The page of FIG. 7A includes similar parts and fields as the page of FIG. 5 and FIG. 6A. For example, the page includes an identification 502 of the service professional. The identification of the service professional may include a photo, a name and a ranking of the service professional and one or more reviews. The page further includes a price 504 quoted by the service professional for the service. The page further includes a message 506, including a customized text with additional details about the quote and/or the service professional; a text box 507 for writing messages to the professional; and a graphical element (508) “About the pro” that enables the customer to view additional information related to the professional (not shown).

The page further includes a “hire” button 503A, which when selected enables the customer to hire the service professional for performing the requested service; and a “decline” button 503B, which when selected enables the customer to decline hiring (and discard the quote) the service professional for performing the requested service. The page also includes a “next step” section 525 of activity meetings suggested by the service professional as next steps in the quoting process. In the illustrated example, the service professional (here referred to as “pro” in FIG. 7A) recommends a meeting activity 525A of type “30-minute in-person meeting,” and suggests three different days/times 525B for the meeting activity. In some embodiments, when the system is aware of the location of the customer, prior to transmitting the quote to the customer, the system may account for time zones by automatically translating the time/date entered by the service professional into a date/time of the time zone of the customer. The next step section 525 further includes a message 525C indicating to the customer that the proposed dates and times can be modified. The customer is prompted to select one of the three suggested dates/times or to contact the professional for setting alternative times and dates for the meeting.

In the scenario, where the customer decides to decline the proposed times/dates, the customer is prompted to select a type of activity and one or more dates and times for the activity. In this exemplary embodiment, the graphical interface includes a button 505B “schedule” which when selected by the potential customer, enables the customer to enter structured information related to the meeting activity. The potential customer is prompted to select a type of activity (when a different activity from the one already proposed by the professional is chosen) and one or more dates and times for the activity. In a similar manner as the process described for the professional (FIGS. 3A-E, where the professional transmits the suggested meeting activity information), the system enables the customer to select alternative dates and times and transmit a notification to the professional indicating that a new message is received from the customer. The professional may then access their account and view the list of meeting activities suggested by the customer.

In the alternative scenario, where the customer selects one of the suggested times/dates 525B (illustrated in FIG. 7B), section 526 of the web page highlights the selected time/date and the customer is prompted to enter a phone number in text box 527A, an address in text box 527B, and a postal code (Zip Code) in text box 527C. In some embodiments, when the customer selects one of the text boxes 527A-C, a set of numbers and or letters (e.g., a keyboard) is displayed (not illustrated) to enable the customer to enter the requested information. Once the customer enters the information (i.e., phone number, address and postal code) in text boxes 527A-C (as illustrated in FIG. 7C), they may schedule the meeting activity by selecting the button 528. FIG. 7D illustrates an exemplary graphic interface of a web page of when the scheduling of the meeting activity is confirmed by the customer. When the customer has completed entering the requested information (e.g., date, time and phone number in this example) and confirmed the meeting activity by selecting the “scheduling meeting” button 528, a confirmation 530 is indicated to the customer including a summary of the agreed upon meeting activity with the associated meeting details (e.g., date, time, call information, etc.).

In the embodiments described above with respect to FIGS. 6A-E and 7A-D, the customer is enabled to agree upon a meeting activity, a date, and time of the meeting activity and optionally of a location for the meeting activity by entering the requested information in a structured manner and without the need for exchanging several messages with the service professional. This enables the peer-to-peer marketplace system to obtain structured data/information regarding the meeting activity that is scheduled between the service professional and the customer during the quotation process. The structured data is easily parsed, analyzed and may be integrated in a seamless manner to other features of the peer-to-peer marketplace system.

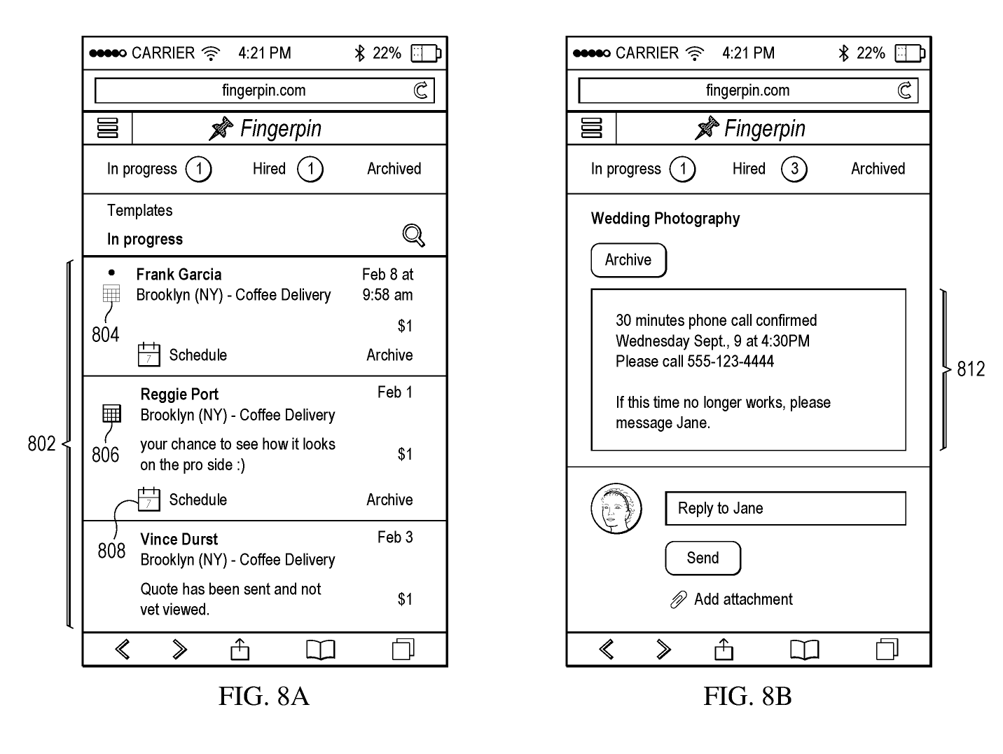

In addition once, a confirmation of a scheduled meeting activity is received from the customer, the system automatically updates the inbox of the service professional to include the scheduling meeting activity. FIG. 8A illustrates an exemplary graphical interface of a web page of professional quote inbox in accordance with some embodiments. The graphical interface includes a list of quotes 802 that were submitted by the professional to multiple customers for various requests of service. For example, a first quote was submitted to customer “Frank Garcia,” and a second quote was submitted to customer “Reggie Port.” In the illustrated example, meeting activity information is displayed within the graphical interface when available. For example, the first quote (submitted to customer “Frank Garcia”) includes a calendar icon (icon 804), accompanied by text indicating that a meeting activity has been suggested by the professional to the customer but has yet to be confirmed by the customer. A subsequent quote (e.g., submitted to “Reggie Port”) includes a calendar icon (which is here displayed in a color that is different from the one used for displaying the suggested meeting activity) that indicates a confirmed meeting activity. These graphical elements 806 indicate a confirmed meeting activity between the professional and the customer in relation with a desired service. The graphical interface further includes a “schedule” element 808, which when pressed enables the professional to offer additional or alternative times and dates for the meeting activity. In some embodiments, when a quote is selected by the professional a graphical interface offering a more detailed view of the quote is displayed. FIG. 8B illustrates an exemplary graphical interface of a web page of a summary message including all information 812 needed for the agreed upon meeting (date, time, location, and addition contact information (e.g., phone number, address, etc.)) when the professional selects a given quote.

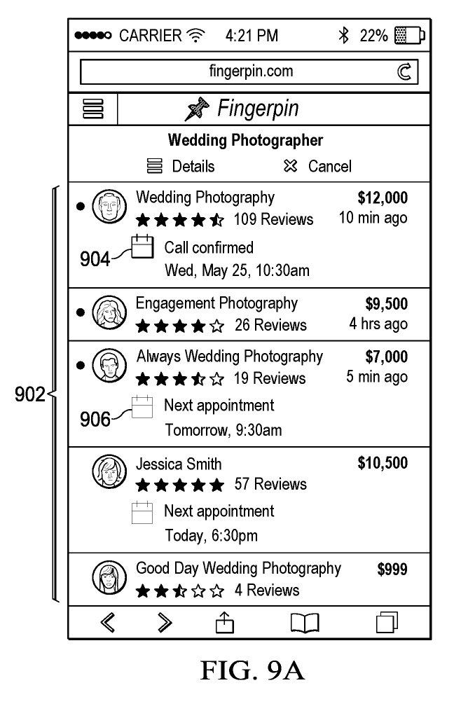

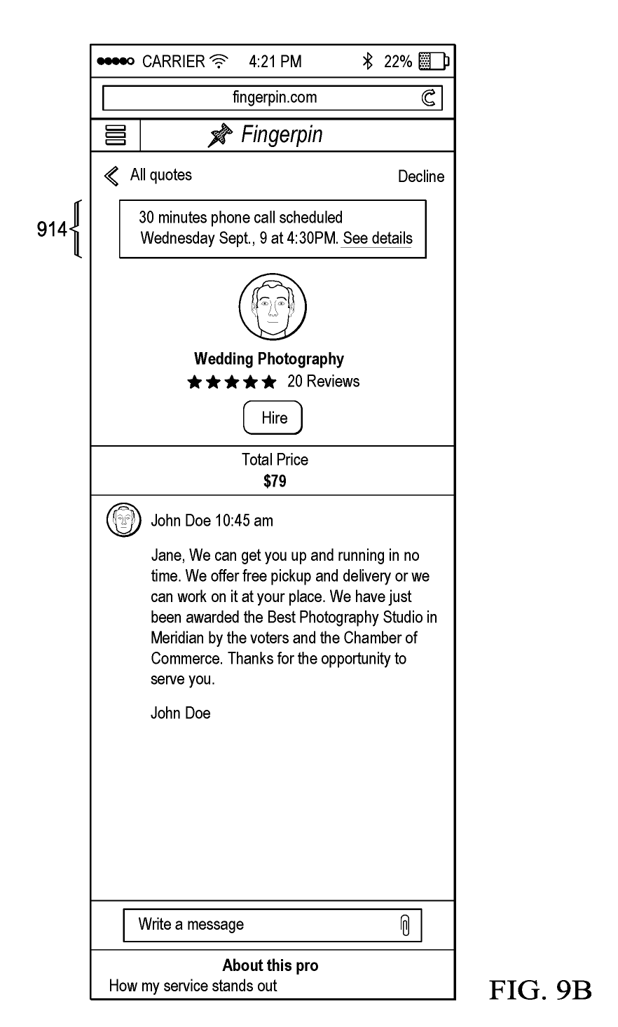

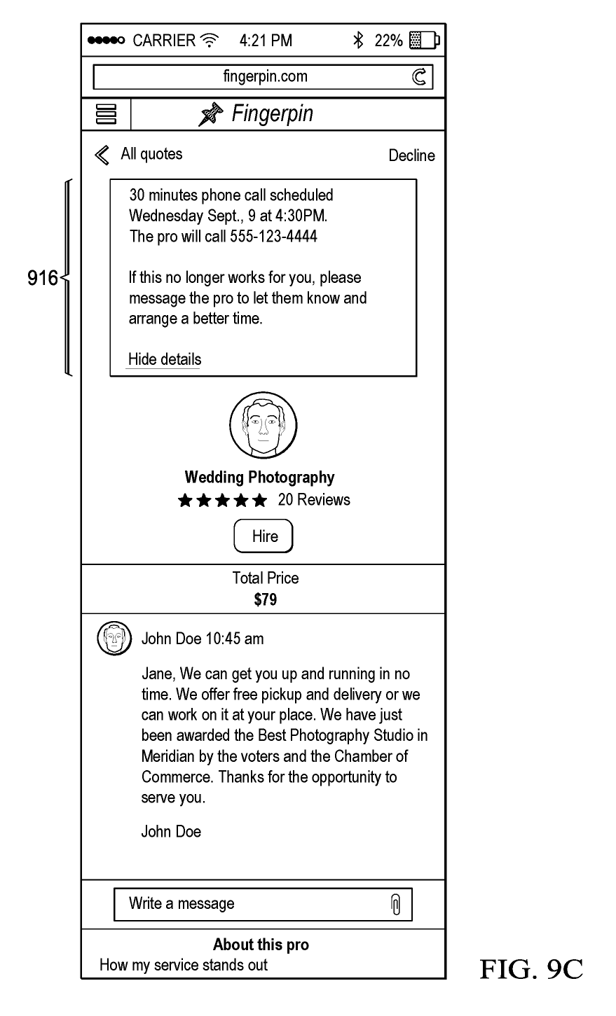

The system further updates the quote inbox of the customer to include the scheduling meeting activity. FIG. 9A illustrates a graphical interface of a web page of a customer's quote list for a given request of service in accordance with some embodiments. The graphical interface includes a list of quotes 902 that were submitted by several professionals for the request of service (e.g., a request for a wedding photography type of service). In the illustrated example, meeting activity information is displayed within the graphical interface when available. For example, the first quote (submitted by professional “Wedding Photography”) includes a calendar icon (icon 904), accompanied by text indicating that a call has been confirmed along with the date and time of the call. These elements indicate a confirmed meeting activity between the professional and the customer in relation with a desired service. A subsequent quote (e.g., submitted by “Always Wedding Photography”) includes a calendar icon (which is can be displayed in a color that is different from the one used for displaying the confirmed meeting activity) that is accompanied by text to let the customer know when the professional is available next. These graphical elements 906 indicate one or more proposed times offered by the professional for the meeting activity. In some embodiments, when a quote is selected by a customer a graphical interface offering a more details view of the quote is displayed. FIG. 9B illustrates an exemplary graphical interface of a web page of a summary message including all information needed for the agreed upon meeting (date, time, location, and addition contact information (e.g., phone number, address, etc.)). In some embodiments, the information is added to the quote sent by the service professional and displayed partially (e.g., section 914 of FIG. 9B). The customer is enabled to view additional details if needed by selecting the “see details” button of section 914, and display section 916 (as illustrated in FIG. 9C). In each of these embodiments, when the summary message is viewed within an application (e.g., a dedicated application for the peer-to-peer marketplace, or a mobile web browser, etc.) running on a device coupled with a voice call service, the graphical user interface provides a button, which when selected by the customer and/or the service professional, to call the other party directly from the summary page of the scheduled meeting activity.

Using the structured meeting activity information, which is received by prompting the service professional and/or the potential customer to enter the information, the system is operative to perform a variety of operations in relation to the meeting activity and the quoted service. For example, the system is operative to automatically transmit reminders (e.g., via text message or via email) to each one of the service professional and the customer. The system is further operative to lay out a schedule for the professional with daily meeting activities scheduled. The system is further operative to monitor the date and time of the day and perform actions based on the current date and time and the agreed upon date and time of the meeting activity. For example, the system may send one or more reminders to each one of the customer and the service professional for the meeting activity. The reminders may be sent as text message, emails, voice messages or other. The system may further trigger messages that follow the occurrence of the activity to obtain feedback and data about the meeting activity from each one of the customer and the service professional. The system is further operative to save for each customer contact information received through the quotation process and the scheduling of the meeting activity. The saved information (e.g., phone number, address, etc.) can be used for future quotation processes. For example, the entered address can be automatically set by the system to become the default address of the customer.

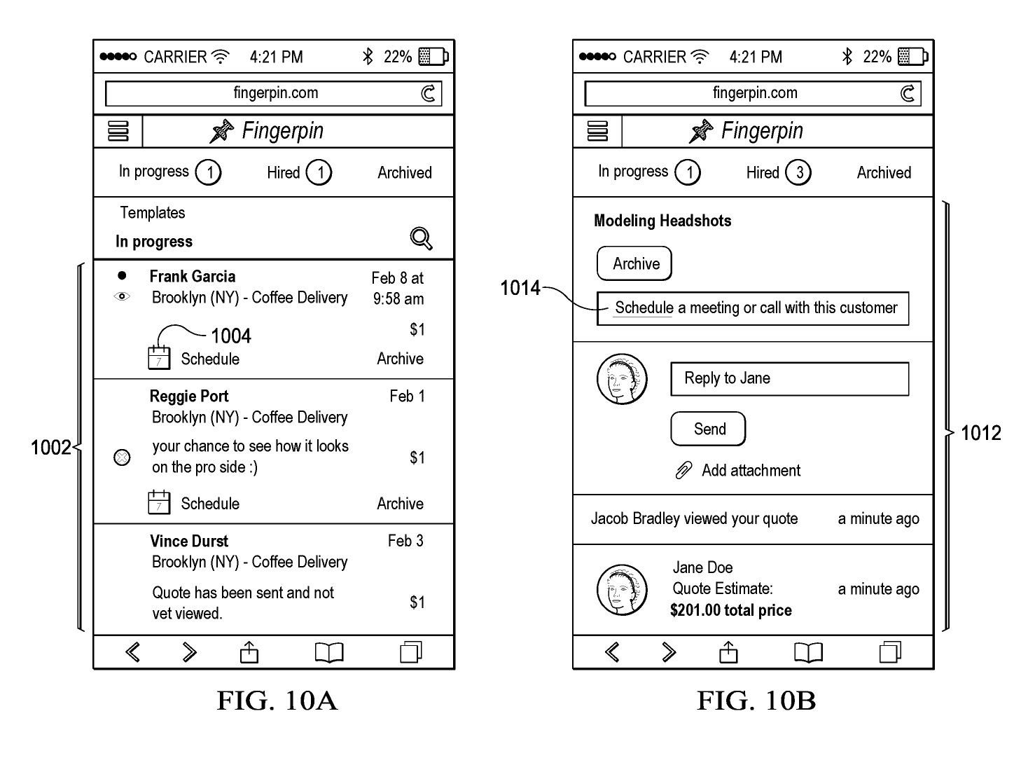

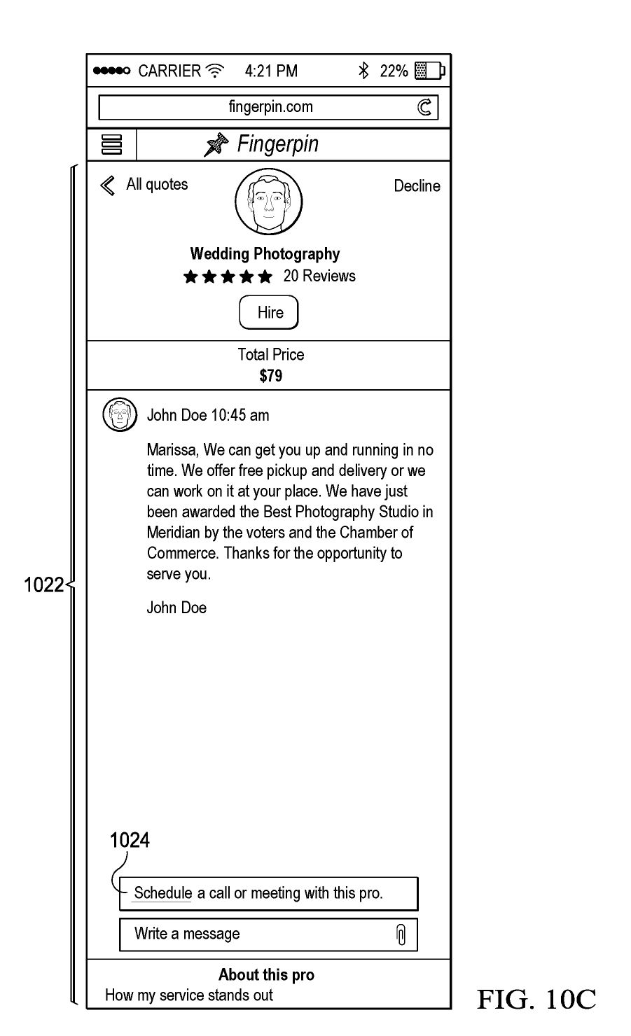

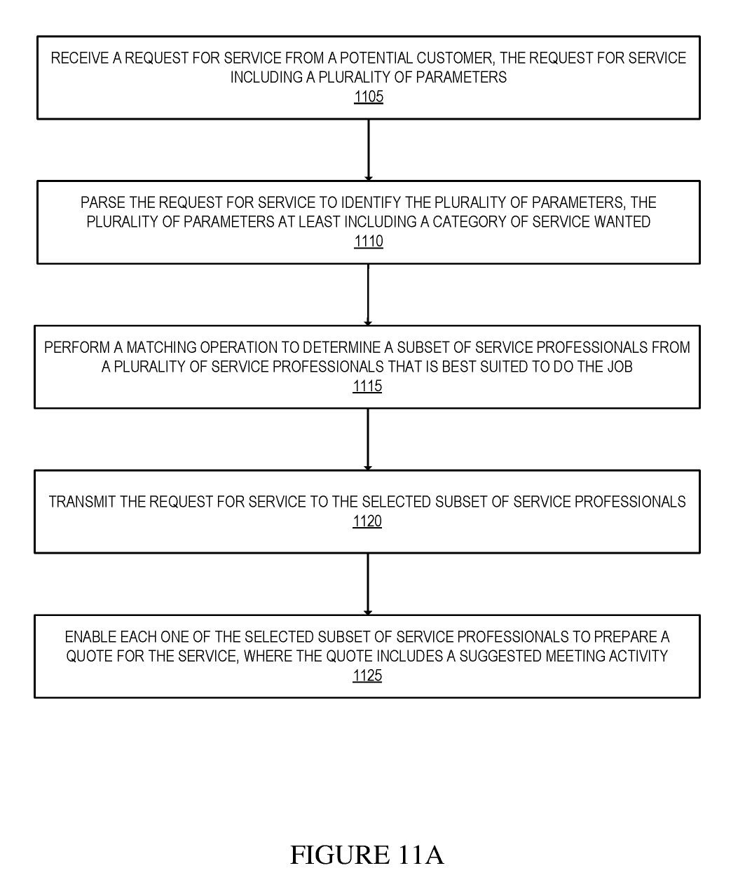

While the embodiments described above (in particular with respect to FIG. 1A) describe scheduling of a meeting activity when first initiated during a quotation process, the scheduling of a meeting activity can be initiated by a professional or a customer outside of the quotation process. FIGS. 10A-C illustrate other examples of graphical interfaces that include a link or graphical element that enable a user of the marketplace peer-to-peer system to initiate the scheduling of a meeting activity with another user.

FIG. 10A illustrates an exemplary graphical interface of a web page of a list of quotes 1002 for enabling a professional to initiate the scheduling of a meeting activity with a customer of a marketplace of peer-to-peer services, in accordance with some embodiments. In this example, the graphical element 1004 is used to initiate scheduling of a meeting activity with an associated potential customer (e.g., customer Frank Garcia). When selected by the professional, the graphical element 1004 enables the professional to enter structured information related to the meeting activity. In some embodiments, the selection of the meeting activity and corresponding information is performed as described with reference to FIGS. 3A-E.

FIG. 10B illustrates an exemplary graphical interface of a web page of a messenger 1012 of a professional account for enabling the professional to initiate the scheduling of a meeting activity with a customer of a marketplace of peer-to-peer services, in accordance with some embodiments. In this example, the graphical element 1014 is used to initiate scheduling of a meeting activity with an associated potential customer (e.g., customer Frank Garcia). When selected by the professional, the graphical element 1014 enables the professional to enter structured information related to the meeting activity. In some embodiments, the selection of the meeting activity and corresponding information is performed as described with reference to FIGS. 3A-E.

FIG. 10C illustrates an exemplary graphical interface of a web page of a messenger 1022 of a customer account for enabling the potential customer to initiate the scheduling of a meeting activity with a professional offering services through a marketplace of peer-to-peer services, in accordance with some embodiments. In this example, the graphical element 1024 is used to initiate scheduling of a meeting activity with an associated professional. When selected by the potential customer, the graphical element 1024 enables the customer to enter structured information related to the meeting activity. In some embodiments, the selection of the meeting activity and corresponding information is performed as described with reference to FIGS. 3A-E.

FIG. 11B illustrates a flow diagram of exemplary operations for enabling scheduling of a meeting activity between a first user and a second user of a marketplace of peer-to-peer services, in accordance with some embodiments. According to some embodiments of the invention, the operations of FIG. 11B are performed by a system enabling a marketplace of peer-to-peer services between service professionals and customers through a graphical user interface and a backend system operative to display at least the webpages of the FIGS. 1A-10C. FIGS. 11B will be described with reference to the FIGS. 1A-10C. However, it should be understood that the operations of FIGS. 11B can be performed by embodiments of the invention other than those discussed with reference to FIGS. 1A-10C, and the embodiments of the invention discussed with reference to FIGS. 1A-10C can be performed by operations different than those discussed with reference to FIGS. 11B.

In some embodiments, the operations of FIG. 11B are performed following the operations of FIG. 11A, such that the scheduling of a meeting activity is enabled by the system during a quotation process initiated by a service professional. In these embodiments, the first user of the following description is a service professional participating in the quotation process through the graphical interface of the marketplace service, and the second user is the potential customer. In other embodiments, the operations of FIG. 11B can be performed by a service professional or a customer outside of the quotation process. For example, in these embodiments, the operations of FIG. 11A can be initiated by either the professional or the customer from their respective messengers, and/or a list of quotes as described above with respect to FIGS. 10A-10C.

At operation 1130, a set of meeting activity types is selected based upon the category of service wanted. In some embodiments, the set of the meeting activity types is selected to be displayed to the first user that is initiating the scheduling operations. The set of meeting activity types can be automatically selected by the system based upon the category of service wanted.

Flow then moves to operations 1131, at which the service professional is prompted to select a type of meeting activity from the set of meeting activity types. For example, the system may cause an electronic device of the first device to display the graphical interface of FIG. 2A including a set of selected meeting activity types from which the first user is to select one meeting activity type.

Flow then moves to operation 1132, at which the system receives a first input indicating the type of meeting activity desired. In some embodiments, the system receives through the graphical interface of FIGS. 2B and 3A the first input that indicates the type of meeting activity desired by the first user.

Flow then moves to operation 1132, at which the system prompts the first user to enter structured information associated with the meeting activity. In some embodiments, the system prompts through the graphical interface of FIGS. 3B and 3C the first user to enter structured information associated with the meeting activity.

Flow then moves to operation 1133, at which the system transmits to a second user a notification message (e.g., graphical interface of FIG. 4A, FIG. 5, FIG. 6A) including the structured information associated with the meeting activity. Flow then moves to operation 1132, at which the system receives from the second user a response to the notification message including at least one of a confirmation of the meeting activity and updated information for the meeting activity. Flow then moves to operation 1132, at which the system transmits a message (FIG. 8) to the first user including at least one of the confirmation for the meeting activity and the updated information for the meeting activity.

The embodiments of the present invention enable, a service professional and a customer to schedule a meeting activity with a seamless process. The scheduled activity is clearly displayed to both professionals and customers. All information (suggested times, location, phone number) is collected at one time and shared with the other party as needed. In some embodiments, some of the information collected (e.g. phone number, location) is also stored for future use, eliminating the need to repeatedly enter the same information. Up to N specific times/dates can be suggested at a time, eliminating the need for both parties to disclose their entire availability. The confirmation of agreed-upon meeting activity is clearly displayed for both parties (including relevant information like time, phone number and/or location). In some embodiments, personal information (e.g., real name, email address, etc.) is not displayed unless a meeting time is agreed upon.

Architecture

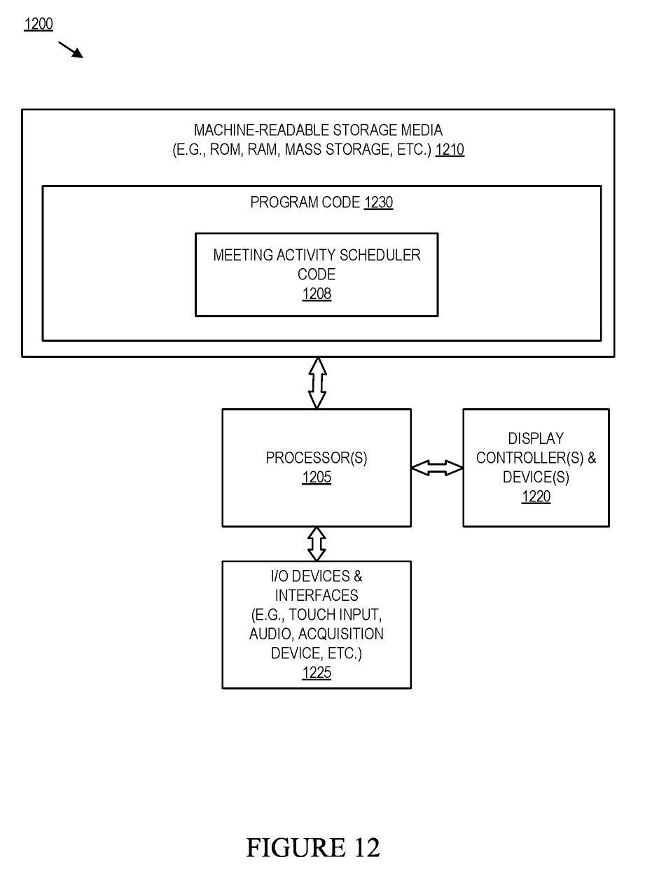

FIG. 12 illustrates a block diagram for an exemplary data processing system 1200 that may be used in some embodiments. Data processing system 1200 includes one or more processors 1205 and connected system components (e.g., multiple connected chips). Alternatively, the data processing system 1200 is a system on a chip or Field-Programmable gate array. One or more such data processing systems 1200 may be utilized to implement the embodiments and operations described with reference to FIGS. 1A-11B.

The data processing system 1200 is an electronic device which stores and transmits (internally and/or with other electronic devices over a network) code (which is composed of software instructions and which is sometimes referred to as computer program code or a computer program) and/or data using machine-readable media (also called computer-readable media), such as machine-readable storage media 1210 (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals), which is coupled to the processor(s) 1205. For example, the depicted machine readable storage media 1210 may store program code 1230 that, when executed by the processor(s) 1205, causes the data processing system 1200 to enable scheduling of a meeting activity between a service professional and a potential customer. For example, the program code 1230 may include meeting activity scheduler code 1208, which when executed by the processor(s) 1205, causes the data processing system 1200 to perform the operations described with reference to FIGS. 1A-11B. In some embodiments, the meeting activity schedule code 1208 may be stored on a centralized (backend) electronic device that is in communication with multiple electronic devices of service professionals and/or customers. In some embodiments, the meeting activity scheduler code 1208 may include one or more subsets of codes stored on separate electronic devices, where each subset when executed on the respective electronic device causes the electronic device to perform some or all of the operations described with reference to FIGS. 1A-11B.

Thus, an electronic device (e.g., a computer or a mobile device) includes hardware and software, such as a set of one or more processors coupled to one or more machine-readable storage media to store code for execution on the set of processors and/or to store data. For instance, an electronic device may include non-volatile memory containing the code since the non-volatile memory can persist the code even when the electronic device is turned off, and while the electronic device is turned on that part of the code that is to be executed by the processor(s) of that electronic device is copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

The data processing system 1200 may also include a display controller and display device 1220 to provide a visual user interface for the user, e.g., GUI elements or windows. The visual user interface (or graphical interface) may be used to enable a user to input structured information related to the scheduling of a meeting activity, for example as illustrated with respect to FIGS. 1A-10C.

The data processing system 1200 also includes one or more input or output (“I/O”) devices and interfaces 1225, which are provided to allow a user to provide input to, receive output from, and otherwise transfer data to and from the system. These I/O devices 1225 may include a mouse, keypad, keyboard, a touch panel or a multi-touch input panel, camera, frame grabber, optical scanner, an audio input/output subsystem (which may include a microphone and/or a speaker for, for example, playing back music or other audio, receiving voice instructions to be executed by the processor(s) 1205, playing audio notifications, etc.), other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 1200.

The I/O devices and interfaces 1225 may also include a connector for a dock or a connector for a USB interface, FireWire, Thunderbolt, Ethernet, etc., to connect the system 1200 with another device, external component, or a network. Exemplary I/O devices and interfaces 1225 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 1200 with another device, external component, or a network and receive stored instructions, data, tokens, etc. It will be appreciated that one or more buses may be used to interconnect the various components shown in FIG. 12.

It will be appreciated that additional components, not shown, may also be part of the system 1200, and, in certain embodiments, fewer components than that shown in FIG. 12 may also be used in a data processing system 1200.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense. For example, while the flow diagrams in the figures show a particular order of operations performed by certain embodiments of the invention, it should be understood that such order is exemplary. One having ordinary skill in the art would recognize that variations can be made to the flow diagrams without departing from the broader spirit and scope of the invention as set forth in the following claims (e.g., alternative embodiments may perform the operations in a different order, combine certain operations, overlap certain operations, etc.).

Some portions of the preceding detailed descriptions have been presented in terms of algorithms and symbolic representations of transactions on data bits within a computer and memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

1. A method for enabling scheduling of a meeting activity between a service professional and a potential customer of a service, the method comprising:
receiving a request for service from a potential customer, the request for service including a plurality of parameters;
automatically parsing the request for service to identify the plurality of parameters, wherein the plurality of parameters at least include a category of service wanted;
automatically performing a matching operation to determine a subset of two or more service professionals from a plurality of service professionals that is best suited to do the job;
automatically transmitting the request for service to the subset of service professionals, wherein the request includes at least the category of service wanted;
automatically prompting the service professional to select a quote for responding to the request;
automatically selecting based upon the category of service wanted, a set of meeting activity types;
automatically prompting the service professional to select a type of meeting activity from the set of meeting activity types;
receiving a first input indicating a type of a meeting activity desired, wherein the meeting activity is to be performed by the service professional and the potential customer prior to the potential customer hiring the service professional to perform the service;
automatically prompting the service professional to enter structured information associated with the meeting activity;
transmitting to the potential customer a notification message including the selected quote and the structured information associated with the meeting activity;
automatically transmitting a confirmation notification message to the service professional indicating that the selected quote and the structured information associated with the meeting activity were sent to the potential customer;
receiving from the potential customer a response to the notification message including at least one of a confirmation of the meeting activity and updated information for the meeting activity; and
automatically transmitting a message to the service professional including at least one of the confirmation for the meeting activity and the updated information for the meeting activity.

2. The method of claim 1, wherein prompting the service professional to enter the structured information associated with the meeting activity includes causing display of a graphical interface on an electronic device of the service professional including structured graphical elements for receiving structured inputs from the service professional.

3. The method of claim 1, wherein the structured information includes at least one of a date, time and location of the meeting activity desired.

4. The method of claim 1, wherein transmitting to a customer a notification message includes transmitting at least one of an email or a text message to an electronic device of the customer.

5. The method of claim 1, wherein receiving from the customer a response to the notification messages includes prompting the customer to enter structured updated information associated with the meeting activity.

6. The method of claim 5, wherein the updated information includes at least one of a new date, time and location input by the customer through a graphical user interface caused to be displayed on an electronic device of the customer.

7. The method of claim 1, wherein the type of meeting activity is at least one of a phone call and an in-person meeting.

8. A non-transitory computer readable storage medium, that when executed by a processor causes said processor to perform the operations comprising:
receiving a request for service from a potential customer, the request for service including a plurality of parameters;
automatically parsing the request for service to identify the plurality of parameters, wherein the plurality of parameters at least include a category of service wanted;
automatically performing a matching operation to determine a subset of two or more service professionals from a plurality of service professionals that is best suited to do the job;
automatically transmitting the request for service to the subset of service professionals, wherein the request includes at least the category of service wanted;
automatically prompting the service professional to select a quote for responding to the request;
automatically selecting based upon the category of service wanted, a set of meeting activity types;
automatically prompting the service professional to select a type of meeting activity from the set of meeting activity types;
receiving a first input indicating a type of a meeting activity desired, wherein the meeting activity is to be performed by the service professional and the potential customer prior to the potential customer hiring the service professional to perform the service;
automatically prompting the service professional to enter structured information associated with the meeting activity;
automatically transmitting to the potential customer a notification message including the selected quote and the structured information associated with the meeting activity;
automatically transmitting a confirmation notification message to the service professional indicating that the selected quote and the structured information associated with the meeting activity were sent to the potential customer;
receiving from the customer a response to the notification message including at least one of a confirmation of the meeting activity and updated information for the meeting activity; and
automatically transmitting a message to the service professional including at least one of the confirmation for the meeting activity and the updated information for the meeting activity.

9. The non-transitory computer readable storage medium of claim 8, wherein prompting the service professional to enter the structured information associated with the meeting activity includes causing display of a graphical interface on an electronic device of the service professional including structured graphical elements for receiving structured inputs from the service professional.

10. The non-transitory computer readable storage medium of claim 8, wherein the structured information includes at least one of a date, time and location of the meeting activity desired.

11. The non-transitory computer readable storage medium of claim 8, wherein transmitting to a customer a notification message includes transmitting at least one of an email or a text message to an electronic device of the customer.

12. The non-transitory computer readable storage medium of claim 8, wherein receiving from the customer a response to the notification messages includes prompting the customer to enter structured updated information associated with the meeting activity.

13. The non-transitory computer readable storage medium of claim 12, wherein the updated information includes at least one of a new date, time and location input by the customer through a graphical user interface caused to be displayed on an electronic device of the customer.

14. The non-transitory computer readable storage medium of claim 8, wherein the type of meeting activity is at least one of a phone call and an in-person meeting.
